(19) United States
(12) Patent Application Publication
(10) Pub. No.: US 2008/0147349 A1
(43) Pub. Date: Jun. 19, 2008

(54) Control and/or Regulating Device for a Supporting Roll Frame of a Continuous Casting Device for Metal, Especially Steel

(76) Inventors: Ronald Wilmes, Solingen (DE); Hans Esau Klassen, Willich (DE); Bujor Dumitriu, Duesseldorf (DE); Paul-Christian Hopp, Neuss (DE); Christian Geerkens, Juechen (DE)

Correspondence Address: ABELMAN, FRAYNE & SCHWAB, 666 THIRD AVENUE, 10TH FLOOR, NEW YORK, NY, 10017, US

(21) Appl. No.: 11/665,275

(22) PCT Filed: Nov. 4, 2005
(86) PCT No.: PCT/EP2005/011845

§ 371 Date: Apr. 10, 2007

(30) Foreign Application Priority Data
Nov. 9, 2004 (DE) 10 2004 054 296.1

(51) Int. Cl. G01C 9/00

(52) U.S. Cl. 702/150

(57) ABSTRACT

A controlling and/or regulating device for a supporting roll stand (2) of a continuous casting installation (1) for metals, especially for steel materials (3), comprises a plurality of successive roll segments (8) with lower frames (11) and upper frames (12) which can be adjusted relative to the other and pairs of piston-cylinder units (13). The measurement data of field devices (14) are acquired locally and processed. The controlling and/or regulating device simplifies the field cabling and the regulating concept by relocating functions to or next to a roll segment (8) in that the field devices (14) are arranged at or on the roll segment (8) or in the vicinity of the roll segment (8) at the stationary shop scaffold (17), and their measurement signals are processed by axle regulators (18) and are stored and communicate with a memory-programmable control unit (19) by a fieldbus module (20).

The invention is directed to a controlling and/or regulating device for a supporting roll stand of a continuous casting installation for metals, especially for steel materials, which comprises a plurality of successive roll segments, each of which can be adjusted relative to the other in a regulated manner by the lower frame carrying the supporting rolls and an oppositely located upper frame by means of pairs of piston-cylinder units for conveying, straightening and/or improving the internal quality and for altering thickness. The measurement data of field devices are acquired locally and processed.

In order to adjust only one hydraulic cylinder, the various signals which occur in the area of this hydraulic cylinder and which must be converted have to be electrically connected to a regulating part. Consequently, on the one hand, the field cabling of the roll segments and therefore the entire guiding of the strand up to the centrally installed regulating circuit is very complicated. On the other hand, a central regulating circuit is also very uneconomical because of the large quantity of signals to be processed.

The distance to the regulating circuit in the control cabin on the casting floor is still very great and may be as long as 100 m. Since every roll segment has four position transmitters, four sets of regulating valves (servo valves or switching valves) and, in some cases, eight pressure transducers and/or pressure transmitters, there are four synchronous serial interfaces and twelve analog or digital signals to be processed for each segment. There are often more than 15 adjusted roll segments in a continuous casting installation: there are 60 synchronous serial interfaces and 180 analog signals or 240 digital signals of a regulating valve to be processed in these roll segments. In view of this large number of signals to be processed, the cost of a central regulating circuit is too high and the central regulating circuit is taxed to the limits of its capability.

A known local regulating circuit (WO 01/94052 A1) utilizes a method for local processing of casting data given by measurement data obtained from a continuous casting mold by sensors. The data processing is carried out in a process computer of the control system of the continuous casting installation. The method increases the efficiency of the measuring path and simplifies the device in that the measurement data and control data are collected directly from the continuous casting mold in cooled fieldbus modules, converted to bus signals in a bus line, stored at least in the control system of the continuous casting installation, and/or processed.

It is the object of the invention to improve the field cabling and the concept for regulating the guiding of the strand by relocating functions to or next to a roll segment.

This object is achieved according to the invention in that the field devices are arranged at or on the roll segment or in the vicinity of the roll segment at the stationary shop scaffold, and their measurement signals are processed by axle regulators and are stored and communicate with a memory-programmable control unit by a fieldbus module. The occurring measurement signals are processed and stored immediately in situ in smaller regulating circuits (the axle regulators). An axle regulator of this type operates separately for each roll segment and takes over all regulating and monitoring tasks. All of the axle regulators communicate with a memory-programmed control unit via a fieldbus module. Axle regulators of this kind are circuits which are based on special microprocessors and are used for controlling servo axes. The standard software in the movement control unit adds a real-time control for the axle adjustment. For example, the movement control unit has interfaces for:

absolute or incremental position transmitters

digital or analog inputs or outputs

a fieldbus

a network.

The movement control unit used for the application comprises a keyboard and a data display device (display). The application software is standard and is stored in a repeatable memory. The movement control unit is able to control a plurality of axes. Based on a graphic menu, the movement control unit is adapted by means of parameters to the type of axle and to the type of position return. Programming is not necessary. The movement control unit obtains the required reference values and the starting movement via the fieldbus connection or the network connection and feeds them back to the master system with the position and a status display. Application is carried out on the piston-cylinder units of the roll segments, i.e., their main axles, e.g., the hydraulic cylinder axle.

An improvement in the regulation and control is achieved basically by two types of circuits.

In a first embodiment form, the field devices are connected to the axle regulator in a terminal box on the upper frame of the roll segment, switching valves being provided on the upper frame of the roll segment and connected to the axle regulator, and is connected from the axle regulator via a detachable media coupling by cable packages to a terminal box arranged on the stationary shop scaffold with the memory-programmable control unit in a control space of the continuous casting installation by a fieldbus module. The axle regulators contain set value data and send back alerts or report disturbances to the memory-programmable control unit. The memory-programmable control unit can also transmit this information to a visualization device. When the quantity of roll segments varies in different continuous casting installations, expenditure for the application software in the memory-programmable control unit can be minimized.

A second embodiment form is designed in such a way that the signals of the position sensors are fed from the hydraulic cylinders to a terminal box in each instance on the upper frame of the roll segment, a cable package formed by a detachable media coupling is guided from the roll segment to the stationary shop scaffold or to the continuous casting installation and an axle regulator, a valve stand on the stationary scaffold is connected to the axle regulator, and the signals are fed from the axle regulator via a fieldbus module to the memory-programmable control unit in a control space of the continuous casting installation. The control and regulation are also improved and simplified in this way.

One embodiment provides that the axle regulator processes the stored signals for positioning the supporting rolls, synchronizing the driven supporting rolls of neighboring roll segments, for left-hand or right-hand hydraulic cylinders or for the in-going side or out-going side, monitoring the status of the sensors, roll segment coding, maintenance, and the like.

In another embodiment, the terminal boxes are cooled by means of the machine cooling water available on the upper frame of the roll segment.

Further inventive features consist in that the fieldbus modules can be physically connected by electric metal lines, light waveguides or wireless transmission devices, or infrared signals. In the first embodiment example for the signal transmission, three cables are sufficient for supplying a roll segment: for the power supply of the axle regulator, the power supply of the fieldbus module, and for the data of the fieldbus module.

Other features consist in that the cables of the cable package for the power supply, axle regulators and fieldbus modules are connected by a shared plug-in connection.

Finally, another embodiment consists in that the cables for the signals of the position transmitters from the terminal box to the roll segment are formed by a media coupling as a detachable plug-in connection to the axle regulator. In this case, the position sensors of each roll segment which are integrated in the hydraulic cylinders need only be connected to the axle regulator that is installed in situ by the plug-in connection to the valve stand from the shop scaffold and from the latter with all other signals.

Embodiment examples of the invention are shown in the drawing and are described in more detail below.

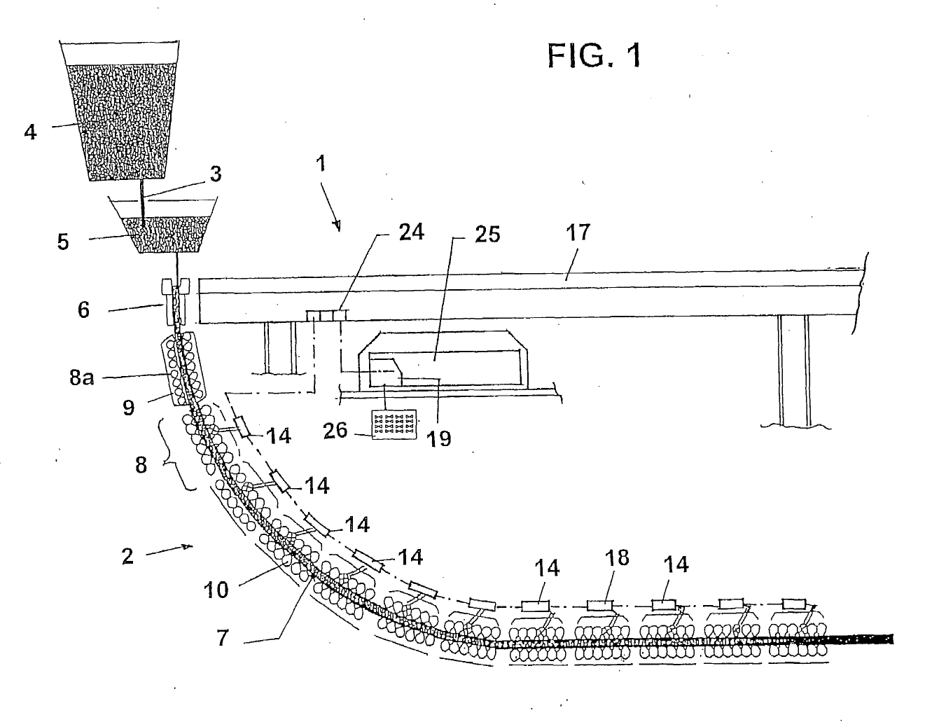

FIG. 1 is a side view of a continuous casting installation with a shop scaffold;

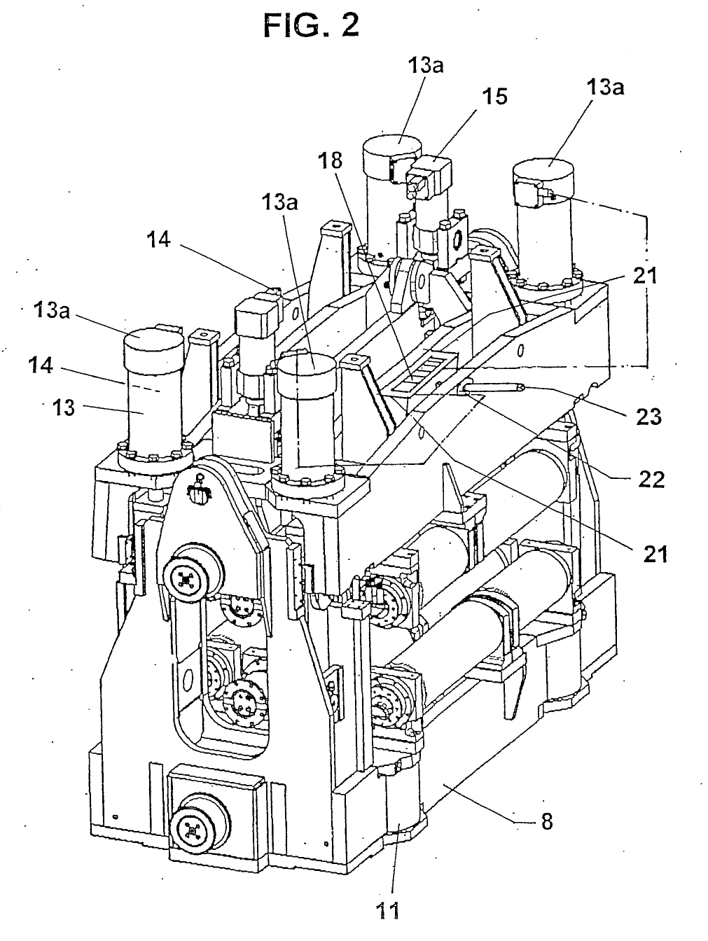

FIG. 2 shows a roll segment in a perspective view;

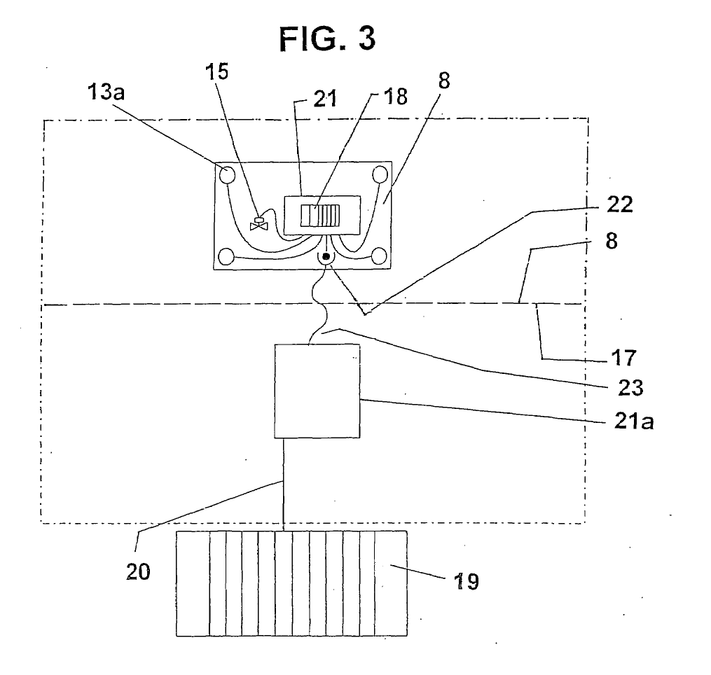

FIG. 3 is a schematic block diagram of a first embodiment example; and

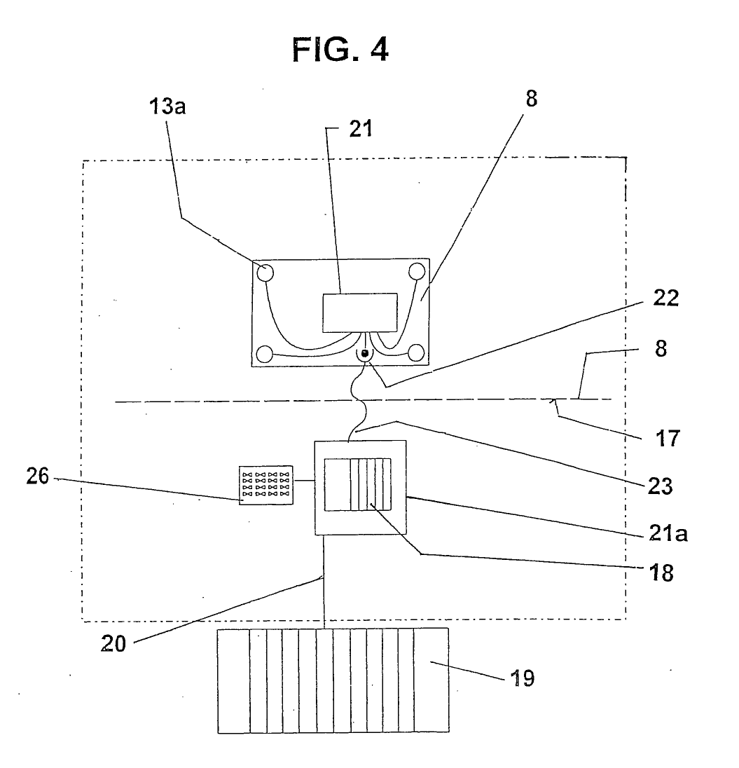

FIG. 4 is a schematic block diagram of a second embodiment example.

The continuous casting installation 1 according to FIG. 1 has a supporting roll stand 2 in which the cast strand 7 of liquid steel material 3 which flows from a casting ladle 4 via a tundish 5 and a continuous casting mold 6 and which is partially cooled is supported and further cooled. The supporting roll stand 2 comprises a plurality of roll segments 8, often up to 15. The first roll segment 8a is enclosed by a steam chamber 9. Each successive roll segment 8 is formed by a lower frame 11 carrying supporting rolls 10 and an upper frame 12 which is located across from the lower frame 11. The lower frame 11 and the upper frame 12 can be adjusted relative to one another in a regulated manner by pairs of piston-cylinder units 13 (see FIG. 2), two of which pairs are shown with their hydraulic cylinders 13a in FIG. 2. The measurements of hydraulic pressures, positions of the pistons, etc. with the results from measurement data are obtained out by means of sensors, position transmitters, pressure transmitters, regulating valves, and the like, all of which are included under the term “field devices” 14. Further, switching valves 15 and regulating valve blocks 16 are used. The piston-cylinder units 13 which are controlled and/or regulated in this way convey and straighten the cast strand 7 and/or improve the internal quality thereof and take into account local changes in thickness along the supporting rolls 10.

The field device 14 of two types can replace a central regulating system by a local regulating system: the field device 14 is arranged at or on the roll segment 8 or in the vicinity of the roll segment 8 at the stationary shop scaffold 17, and its measurement signals are processed and stored by axle regulators 18 which communicate with a memory-programmable control unit 19 and with a fieldbus module 20.

The first type of association of measurement elements and groups of components consists in that the field devices 14 at or on the roll segment upper frame 12 are connected with the axle regulator 18 in a terminal box 21, a switching valve 15 is provided on the roller segment upper frame 12 and is connected with the axle regulator 18 and from the axle regulator 18 via a detachable media coupling 22 by a cable package 23 with a stationary terminal box 24 on the stationary shop scaffold IT (FIG. 1), and is connected via the fieldbus module 20 with the memory-programmable control unit 19 in a control compartment 25 of the continuous casting installation 1 (FIG. 3).

The second type of association of measurement elements and groups of components according to FIG. 4 consists in that the signals of the position transmitters are guided from the hydraulic cylinders 13a to the terminal box 21 on the upper frame of the roll segment 12. A cable package 23 which is formed by a detachable media coupling 22 is guided from its roll segment 8 to the stationary shop scaffold 17 or to the continuous casting installation 1 and the axle regulator 18. A valve stand 26 is connected to this axle regulator 18 on the stationary scaffold 17. The signals from the axle regulator 18 are fed by the fieldbus module 20 to a memory-programmable control unit 19 in the control space 25 of the continuous casting installation 1.

The axle regulator 18 processes the stored signals for positioning and synchronization, for the left-hand and right-hand hydraulic cylinders 13a, or for the activation of the in-going side or out-going side of the cast strand 7, the status of the sensors, roll segment coding, maintenance, or the like functions.

The terminal boxes 21 on the upper frame 12 of a roll segment 8 are cooled by means of the machine cooling water otherwise available at that location.

The fieldbus modules 20 are physically attached and connected by electric metal lines, light waveguides or wireless transmission devices, or infrared signals.

The cables of the cable package 23 for the power supply convey the power for the axle regulators 18 and fieldbus modules 20 and form a common plug-in connection 22a.

### LIST OF REFERENCE NUMERALS

1 continuous casting installation
2 supporting roll stand
3 liquid steel material
4 casting ladle
5 tundish
6 continuous casting mold
7 cast strand
8 roll segment
8a first roll segment
9 chamber
10 supporting roll
11 lower frame
12 upper frame
13 piston-cylinder unit
13a hydraulic cylinder
14 field device
15 switching valve
16 regulating valve block
17 shop scaffold
18 axle regulator
19 memory-programmable control unit
20 fieldbus module
21 terminal box at the roll segment
21a terminal box at the shop scaffold
22 detachable media coupling
22a shared plug-in connection
23 cable package
24 stationary terminal box
25 control space
26 valve stand

1-8. (canceled)

9. Controlling and/or regulating device for a supporting roll stand (2) of a continuous casting installation (1) for metals, especially for steel materials (3), which comprises a plurality of successive roll segments (8), each of which can be adjusted relative to the other in a regulated manner by the lower frame (11) carrying the supporting rolls (10) and an oppositely located upper frame (12) by means of pairs of piston-cylinder units (13) for conveying, straightening and/or improving the internal quality and for altering thickness, wherein on the upper frame (12) of a roll segment (8), signals of position sensors of the hydraulic cylinder units (13) are respectively communicated to a terminal box (21), and wherein from the terminal box (21), a cable package (23) is guided via a detachable media coupling (22) to a stationary shop scaffold (17),
characterized in that
for each roll segment (8), a separate axle regulator (18) with a connected therewith, valve stand (26) are arranged on a stationary shop scaffold (17), and signals from all of the axle regulators (18) are communicated over respective fieldbus module (20) to a common memory-programmable control unit (19) in a control compartment (25) of the continuous casting installation (1).

10. Device according to claim 1,
characterized in that
the axle regulator (18) processes the stored signals for positioning the supporting rolls (10), for synchronizing the driven supporting rolls (10) of a adjacent roll segment (8), for left-hand or right-hand hydraulic cylinders (13a) or for the inlet side or outlet side, for monitoring the status of the sensors, roll segment coding, maintenance cycles, and the like.

11. Device according to claim 1,
characterized in that
the terminal boxes (21) are cooled by means of the machine cooling water available on the upper frame (12) of the roll segment (8).

12. Device according to claim 1,
characterized in that
the fieldbus modules (20) are connectable by electric metal lines, light waveguides or wireless transmission devices, or infrared signals.

13. Device according to claim 1,
characterized in that,
the cables of the cable package (23) for the power supply, axle regulators (18) and fieldbus modules (20) are connected by a common plug-in connection (22a).

14. Device according to claim 1,
characterized in that,
the cables for the signals of the position sensors from the terminal box (21) to the roll segment (8) are formed by a media coupling (22) as a detachable plug-in connection (22a) to the axle regulator (18).
